(19) United States
(12) Patent Application Publication
(10) Pub. No.: US 2007/0072717 A1
(43) Pub. Date: Mar. 29, 2007

(54) Double-sided engagement type silent chain

(75) Inventor: Toshitaka Ogo, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/498,593

(22) Filed: Aug. 3, 2006

(30) Foreign Application Priority Data
Sep. 26, 2005 (JP) 2005-278616

(51) Int. Cl. F16G 13/04; F16H 7/06

(52) U.S. Cl. 474/212; 474/213; 474/156

(57) ABSTRACT

In a double-sided engagement type silent chain, the backs of the outermost link plates are made higher than those of the inner link plates, and the inner circumferential surfaces of the outer link plates located adjacent the outermost link plates are provided with a metallic carbide coating and formed in the shape of a Japanese “tsuzumi” hand drum.

### CROSS-REFERENCE TO RELATED APPLICATION

This application claims priority on the basis of Japanese patent application 2005-278616, filed Sep. 26, 2005. The disclosure of Japanese application 2005-278616 is hereby incorporated by reference.

### FIELD OF THE INVENTION

This invention relates to silent chain of the type used as a timing chain in an automobile engine, and more specifically to a double-sided engagement type silent chain in the form of an endless loop, which, in an engine, typically has teeth on the inside of the loop in engagement with a crankshaft sprocket, an intake valve cam sprocket, and an exhaust valve cam sprocket, and teeth on the outside of the loop engaged with a sprocket for driving an auxiliary device such as an oil pump or the like.

### BACKGROUND OF THE INVENTION

Japanese Laid-open Patent Publication No. Hei. 11-166600, U.S. Pat. Nos. 6,142,902, 6,334,829, 6,419,604 and 6,440,022, and Japanese Utility Model Publication No. 2553206 all show double-sided engagement type silent timing chains in which link teeth protruding on the inside of a loop formed by the chain engage one or more sprockets while link teeth protruding on the outside side of the loop engage another sprocket so that the inside and outside sprockets rotate in opposite directions.

In a typical engine timing drive, the crankshaft sprocket, and the intake valve and exhaust valve cam sprockets are engaged with teeth on the inside of the loop and rotate in the same direction, while one or more auxiliary sprockets, for example an oil pump driving sprocket, are engaged with teeth on the outside of the loop, and rotate in the opposite direction.

FIGS. 6 and 7 show a conventional double-sided engagement type silent chain 500. The chain is composed of interleaved, alternate, first and second widthwise rows of link plates. A first row consists of inner link plates 510a flanked by a pair of outer link plates 520a. A second row consists of inner link plates 510b flanked by a pair of outer link plates 520b. Link plates 520b are the outermost link plates of the chain. The alternate rows are connected by connecting pins 530, which are fixed in pin holes 512 in the outermost link plates, 520b. The pin-holes in the other link plates, including outer link plates 520a as well as link plates 510a and 510b, fit rotatably on the connecting pins 530 so that the alternating rows of link plates can articulate.

Each link plate has a pair of teeth, the inner link plates 510a and 510b having teeth 511, which protrude in a first direction. The outer link plates 520a and 520b have teeth 521, which protrude in a second direction opposite to the direction in which the teeth 511 of the inner link plates protrude. Thus, when the chain is in the form of an endless loop, in the central part of the chain, widthwise, the inner link plates 510a and 510b have teeth 511 protruding toward the inside of the loop chain, while along both sides of the chain, the outer link plates 520a and 520b have teeth 521 protruding toward the outside of the loop.

The back surfaces 513 of the outer link plates are typically flat, and co-planar in any straight portion of the chain. Likewise, the back surfaces 523 of the inner link plates are typically flat, and coplanar in any straight portion of the chain.

FIG. 8 shows link teeth 511 of the inner link plates 510a and 510b protruding toward the inside of a loop formed by chain 500 and in meshing engagement with sprocket teeth St of a crankshaft sprocket S on a crankshaft R. This double-sided engagement-type chain meshes with the crankshaft sprocket in the same manner in which a conventional single-sided engagement-type chain meshes with a sprocket. The inwardly projecting teeth of the chain come into meshing engagement with camshaft sprockets in a similar manner.

FIGS. 9 and 10 show how teeth 521 of outer link plates 520a and 520b engage sprocket teeth St of a sprocket S, on a shaft R, and disposed on the outside of the loop formed by the chain. As shown in FIG. 11, the sprocket has two sets of teeth, the two sets being axially spaced from each other by a distance such that they can mesh with the teeth of the outer link plates 520a and 520b.

When the link teeth 521 of the outer link plates 520a and 520b engage with the sprocket, the inner link plates 510b come into sliding contact with the inner wall surfaces of the sprocket teeth St. Contact between the inner link plates 510b and the inner wall surfaces of the sprocket teeth prevents lateral wobbling movement of the chain.

As explained above, in the conventional double-sided engagement type silent chain 500, a connecting pin 530 is fitted to the pin hole 512 of the outermost side link plate 520b. The stress applied to the inner circumferential surface of the pin hole 512 in the outermost link plate 520b when outer link plates 520a and 520b both engage a sprocket, and the tensile stress generated at the inner circumferential surface of the pin hole 512 when the connecting pin 530 is fitted to the pin hole, act synergistically to reduce the strength of the outermost link plate 520b.

Since, in the conventional double-sided engagement-type silent chain, the inner link plates 510a and 510b and the outer link plates 520a and 520b have the same shape, the central portions of links, which extend from the tooth gap bottoms to the back surfaces of the link plates are poor in strength. In particularly, when a load is applied to an outermost link plate 520b, that is, a link plate to which a connecting pin 530 is fitted, cracks tend to occur in the vicinity of the tooth gap bottoms, causing a progressive decrease in the strength and a reduction of the rotational fatigue strength of the chain.

Furthermore, although link teeth 521 are formed on the outermost link plates 520b, guide plates having no link teeth can be used instead. In such a case, increased wear can occur in the sprocket teeth where they contact the link teeth 521 of the outer link plates 520a adjacent the guide plates. Increased wear can also occur in the teeth 521. In order to suppress this wear, the plate thickness or the number of the outer link plates can be increased. However, these measures increase the overall width of the chain, which is disadvantageous because more space is required to accommodate the increased width of the chain.

Finally, when the shaft of an auxiliary device such as an oil pump or the like is driven by a sprocket engaged with the outer link plates 520a and 520b on the exterior of the chain loop, the number of the outer link plates 520a and 520b is ordinarily smaller than the number the inner link plates. As a result, bending and sliding loads exerted between the pin holes of the outer link plates 520a and the connecting pins 530 become large and cause increased contact wear between the pin holes of the outer link plate 520a and the connecting pins 530.

Among the objects of the invention are the solution of one or more of the above-mentioned problems, and the provision of a double-sided engagement type silent chain which can suppress the generation of cracks in the tooth gap bottoms of the outermost link plates, significantly suppress intensive contact wear between the pin holes of the outer link plates and the connecting pins, and/or exhibit overall improved fatigue strength.

### SUMMARY OF THE INVENTION

The double-sided engagement type silent chain in accordance with the invention comprises a number of link plates, each having a pair of pin holes and a flat back surface. At least some of the link plates are formed with a pair of teeth for engaging teeth of a sprocket. The link plates are interleaved in alternate rows, and the rows are articulably interconnected to form an endless loop by connecting pins received in the pin holes.

The link plates of the chain include a plurality of inner link plates, disposed at intermediate locations in the widthwise direction of the chain, between sides thereof. The inner link plates have teeth that protrude toward the interior of the loop. The link plates of the chain also include a plurality of outer link plates disposed along both sides of the chain. The outer link plates include outermost link plates on both sides of the chain, and outer link plates adjacent the outermost link plates but disposed inward with respect to the outermost link plates in the widthwise direction of the chain. The pins are secured to the pin holes of the outermost link plates by an interference fit, and extend through, and fit rotatably in, the pin holes of the other link plates.

The pin holes of the outer link plates adjacent the outermost link plates have inner circumferential surfaces covered with a hardened layer consisting of at least one of metallic carbides of chromium, titanium, vanadium and niobium. The minimum height, measured from the back surface to the tooth gap bottom of the outermost link plates is greater than the corresponding minimum height of the inner link plates.

In a preferred embodiment, the pin holes of the outer link plates adjacent the outermost link plates have an inner circumferential surface in the shape of a Japanese hand drum known as a “tsuzumi.” The tsuzumi shape is characterized by a diameter that is enlarged toward both ends of the drum. Thus, the diameter of the tsuzumi-shaped pin hole is smallest at an intermediate location between the plate sides, and becomes progressively larger toward the plate sides.

In use, the chain is typically engaged with a crankshaft sprocket, an intake valve cam sprocket, and an exhaust valve cam sprocket or the like disposed on the inner circumferential side of the chain, and is also engaged with the driving sprocket of an auxiliary device, such as an oil pump or the like, disposed on the outer circumferential side.

Since the inner circumferential surfaces of the pin holes in the outer link plates adjacent the outermost link plates have are covered with a hardened layer consisting of at least one of metallic carbides of chromium, titanium, vanadium and niobium, the wear losses of those pin holes and the pin holes of the inner link plate are equalized. As a result, the loads on the pin holes and the pins are uniformly dispersed, and intensive contact wear between the connecting pins and the pin holes of the outer link plates disposed adjacent the outermost link plates is significantly suppressed.

Furthermore, since metallic carbide layer is extremely hard, it is resistant to wear caused by fine solid components mixed into the chain lubricating oil. The metallic carbide layer has a low affinity for the iron in the connecting pin, and therefore, adhesion between the pin hole and the connecting pin is suppressed even when lubrication is marginally adequate. The metallic carbide layer is also chemically stable and resistant to corrosion by sulfuric acid typically present in the oil of a diesel engine. Thus, the chain of the invention has abroad range of applications.

Further, since the height of a back surface of the outermost link plates is greater than the heights of the back surface of at least the inner link plates, even if excessive stress is applied to the inner circumferential surface of a pin hole in an outermost link plate at the start of engagement with a sprocket tooth, the generation of cracks in a tooth gap bottoms of the outermost link plates is suppressed, and the fatigue strength of the entire chain is improved.

Where the pin holes of the outer link plates adjacent the outermost link plates have tsuzumi-shaped inner circumferential surfaces, even if the connecting pin is deformed due to bending stress, sliding contact wear, known as “dragging,” occurring between the connecting pins and the pin holes, can be avoided. Thus, smooth sliding contact between the pins and the pin holes of the outer link plates adjacent the outermost link plates can be achieved, and a remarkable further enhancement of the fatigue strength of the chain can be realized.

### BRIEF DESCRIPTION OF THE DRAWINGS

FIG. 1 is a plan view of a part of a double-sided engagement type silent chain in accordance with a first embodiment of the invention;

FIG. 2(A) is a partially cut-away side elevational view of portions of the chain shown in FIG. 1;

FIG. 2(B) is a side elevational view of an outer link plate of the chain, adjacent an outermost link plate;

FIG. 2(C) is a cross-sectional view of the link plate of FIG. 2(B) taken on the section plane 2C-2C of FIG. 2(B);

FIG. 3 is an enlarged view showing a link plate of a silent chain, seated by engagement of its outer flanks with teeth of a sprocket;

FIG. 4 is an enlarged view showing a link plate of a silent chain, seated by engagement of its inner flanks with teeth of a sprocket;

FIG. 5 is a partially cut-away side elevational view of portions of a double-sided engagement type silent chain according to a second embodiment of the invention;

FIG. 6 is a plan view showing a part of a conventional double-sided engagement type silent chain;

FIG. 7 is a side elevational view of a portion of the chain shown in FIG. 6;

FIG. 8 is a cross-sectional view showing the engagement of inner link plates with a sprocket;

FIG. 9 is across-sectional view showing the engagement of outer link plates with another sprocket, at a location indicated by the arrow A in FIG. 7;

FIG. 10 is a cross-sectional view showing the engagement of outer link plates with the same sprocket at a location indicated by the arrow B in FIG. 7; and

FIG. 11 is a perspective view, partly in cross-section, showing a sprocket with which outer link plates engage.

### DETAILED DESCRIPTION OF THE PREFERRED EMBODIMENTS

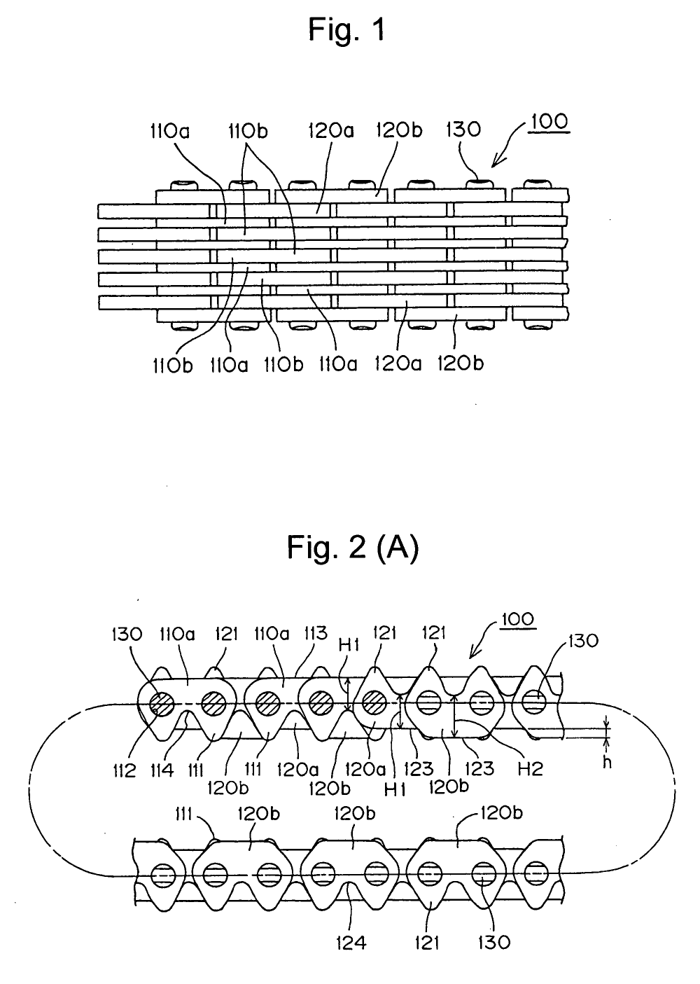

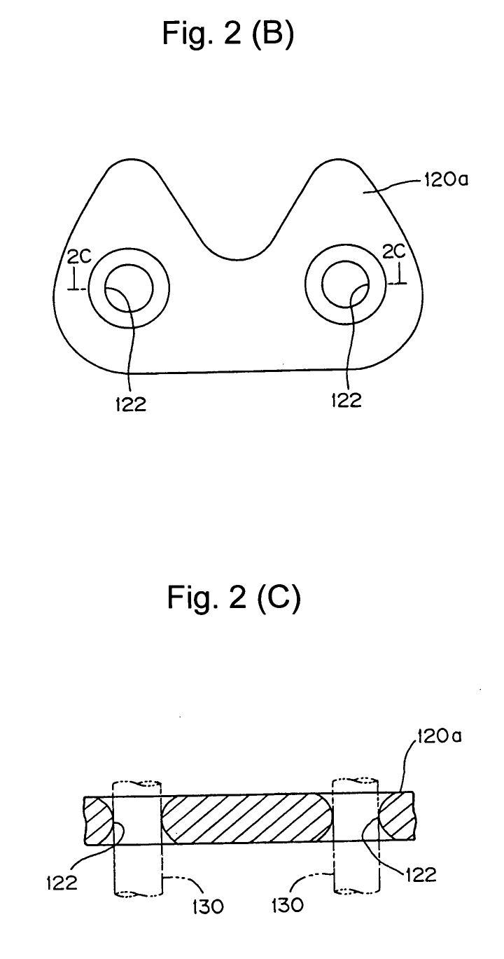

As shown in FIGS. 1 and 2, a double-sided engagement type silent chain in accordance with a first embodiment of the invention. The chain is in the form of an endless loop, as shown in FIG. 2(A), and comprises link plates 110a, 110b, 120a, and 120b. Link plates 110a and 110b are inner link plates, each having a pair of teeth 111. The teeth 110 of the inner link plates protrude toward the interior of the loop. Link plates 120a and 120b are outer link plates, each having a pair of teeth 121. Teeth 121 protrude toward the exterior of the loop. The link plates are arranged in two kinds of widthwise rows. A first kind of row consists of inner link plates 110a and outermost link plates 120b, and a second kind of row consists of link plates 120a, which are adjacent the outermost link plates, and inner link plates 110b. The two kinds or rows are interleaved with one another in alternating, relationship. The link plates are connected by connecting pins 130, which are fitted into pin holes in the outermost link plates 120b with an interference fit, and which fit rotatably in the pin holes, e.g., pin hole 112, of the other link plates 110a, 110b and 120a. With the link plates so arranged, the chain has two, spaced, sets of outwardly protruding teeth on the outer link plates along both sides of the chain, and a set of inwardly projecting teeth on the inner link plates. The inner link plates 110a and 110b, and the outer link plates 120a and 120b, have the same chain pitch, and also have flat back surfaces 113 and 123, respectively.

As shown in FIG. 2(A), the minimum height H2 of the back surfaces 123 of the outermost link plates 120b, measured at a central location in the link plate from the tooth gap bottom 124 to the back surface, is greater, by an amount h, than the minimum height H1 of the back surfaces of the inner link plates 110a and 110b and also greater, by an amount h, than the corresponding minimum height H1 of the outer link plates 120a, which are adjacent the outermost link plates.

Although the heights H2 of the outermost link plates are greater than the heights H2 of the inner link plates and the outer link plates 120a, the height H2 of can vary in accordance with plate strength requirements or other requirements.

The heights H1 and H2 of the link plates are the shortest distances measured at a central location substantially midway between the pin holes, from the tooth gap bottom between the pair of link teeth to the back surface of the link plate.

Since the height of a back surfaces of the outermost link plates 120b is greater than the heights of back surfaces of the inner link plates, even if an excessive stress is applied to the inner circumferential surfaces of the pin holes of the outermost link plates, in which the connecting pins are fitted, generation of a cracks at the tooth gap bottoms 124 of the outermost side link plate 120b is suppressed, and the fatigue strength of the chain is improved.

As shown in FIGS. 1 and 2, the inner link plates 110a and 110b are located at an intermediate location between the sides of the chain, and their teeth protrude toward the inside of the loop in the same way that the teeth of a conventional one-sided engagement type silent chain protrude. Preferably the number of inner link plates in the widthwise direction is an odd number, and the number is seven in the embodiment shown in FIG. 1.

The outer link plates 120a and the outermost link plates 120b are provided along both sides in the widthwise direction of the chain, and their link teeth 121 protrude toward the outside of the loop. The number of outer link plates in the widthwise direction is preferably an even number, in this case, four.

The connecting pins are preferably fitted to the pin holes of the outermost link plates 120b by an interference fit. That is, they can be press-fit in the pin holes outermost link plates. Alternatively, the pins can be secured to the outermost link plates by caulking or the like.

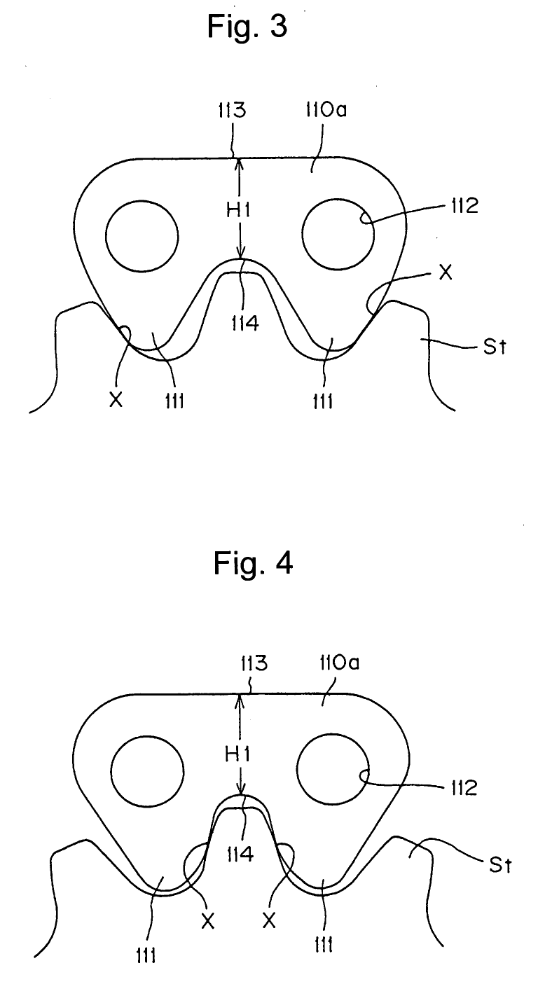

The link plates used in the silent chain of the invention can any of several different types. For example, the plates can be the type in which initial contact between the teeth of the chain and the sprocket teeth is between inner flanks of the teeth of the chain and the chain is ultimately seated, as shown in FIG. 3, with its outer flanks in contact with the sprocket teeth at contact points X. Alternatively, the plates can be of the type in which initial contact between the teeth of the chain and the sprocket teeth is between inner flanks of the teeth and the chain and the chain is ultimately seated with the inner flanks of its teeth engaged with the sprocket teeth at contact points X as shown in FIG. 4. In the former case, as shown in FIG. 3, the loads applied to the central portions of the link plates can be reduced so that the fatigue strength of the link plates is improved.

The pin holes of the outer link plates 120a, that is, the outer link plates disposed adjacent the outermost link plates have their inner circumferential surface covered by a metallic carbide layer, such as chromium carbide (CrC) (not shown) having a Vickers surface hardness of HV 1800 or more and a thickness preferably in the range from 6 μm to 20 μm, i.e., 6×10⁻⁶ m to 2×10⁻⁵ m. The inner circumferential surfaces of the pin holes can be covered with a hardened layer consisting of at least one of metallic carbides of chromium (Cr), titanium (Ti), vanadium (V) and niobium (Nb).

Although it is more important for the pin holes of the outer link plates 120a to have a metallic carbide layer, the inner circumferential surfaces of one or more of the pin holes of the inner link plates may also be covered with a hardened layer consisting of at least one of metallic carbides of Cr, Ti, V and Nb. The coatings on the inner circumferential surfaces of the pin holes of the inner link plates can be different from the coatings on the inner circumferential surfaces of the pin holes of the outer link plates.

Since the pin holes of the outer link plates 120a are covered with the hardened metallic carbide layer, the wear losses of the pin holes of the outer link plates 120a and the wear losses of the pin holes 112 of the inner link plates 110a and 110b are made more nearly equal, the chain pitch remains uniform, and the loads on the link plates and the connecting pins are more uniformly dispersed. Thus, intensive contact wear between the pin hole of the outer link plate 120a and the connecting pins 130 is significantly suppressed.

Furthermore, as mentioned previously, the metallic carbide layer is extremely hard, and resistant to wear caused by fine solid components mixed into the chain lubricating oil. The carbide layer also has a low affinity for the connecting pin, and therefore, adhesion between the pin hole and the connecting pin is suppressed even when lubrication is marginal. The metallic carbide layer is also chemically stable and resistant to corrosion by acid typically present in the oil of a diesel engine

Furthermore, the pin holes of the outer link plates 120a preferably have a tsuzumi-shaped inner circumferential surface 122, as shown in FIGS. 2(B) and 2(C), that is, a surface having a diameter that becomes larger from a central portion of the link plate toward both plate sides.

Because the pin holes of the link plates 120a have a tsuzumi shaped inner circumferential surface, even if the connecting pin 130 is deformed due to bending stress, sliding contact wear, known as “dragging,” occurring between the connecting pins and the pin holes, can be avoided. Thus, smooth sliding contact between the pins and the pin holes of the outer link plates adjacent the outermost link plates can be achieved, and further enhancement of the fatigue strength of the chain can be realized.

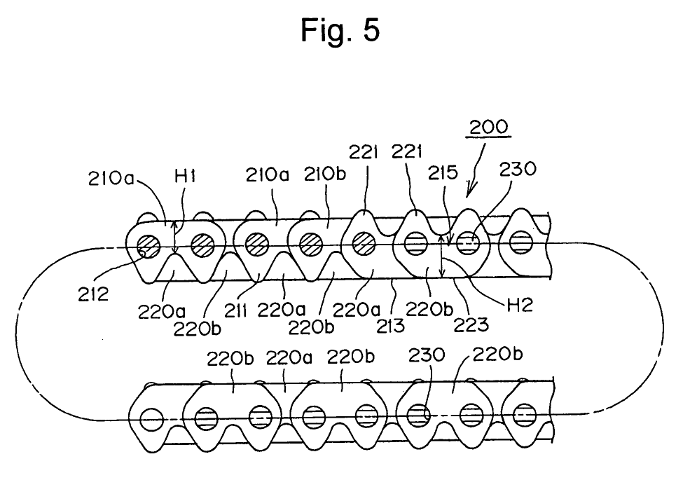

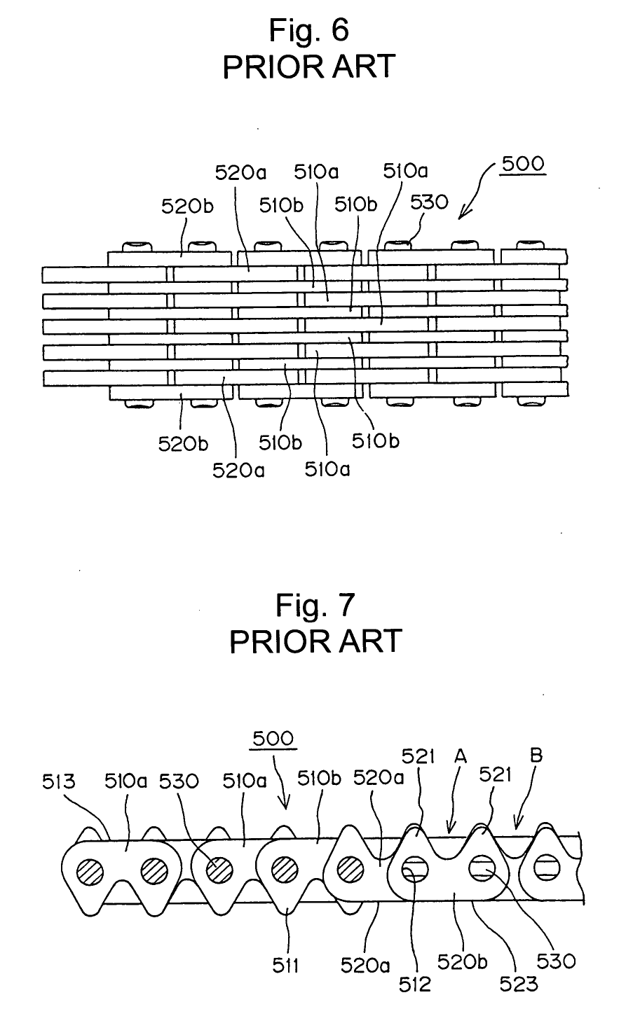

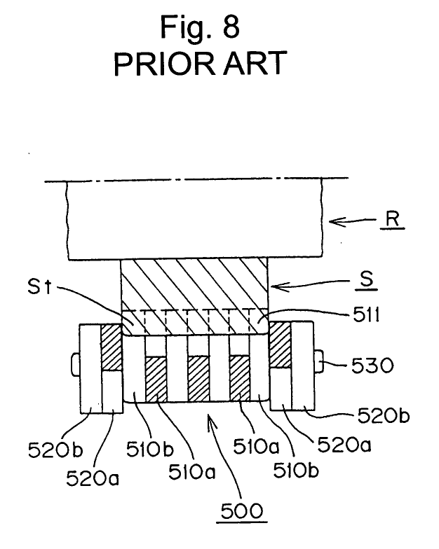

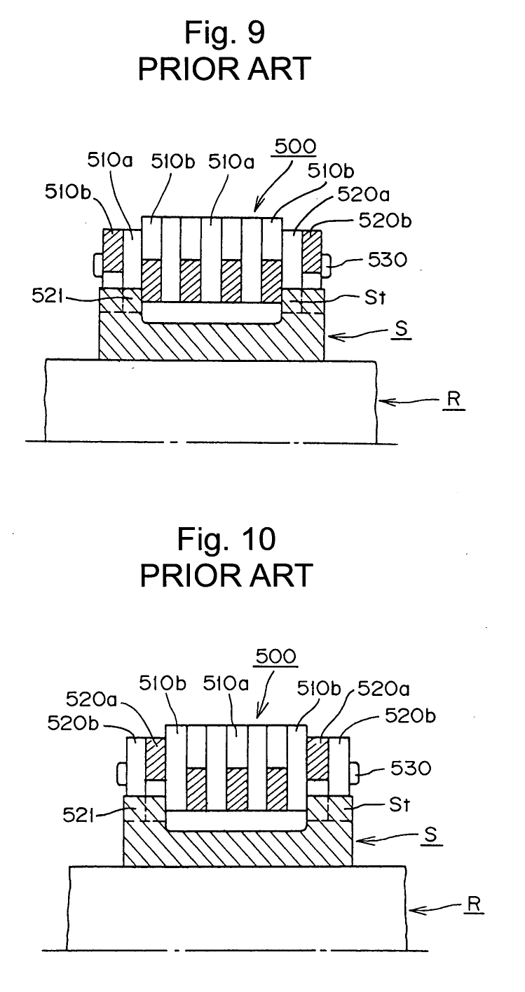

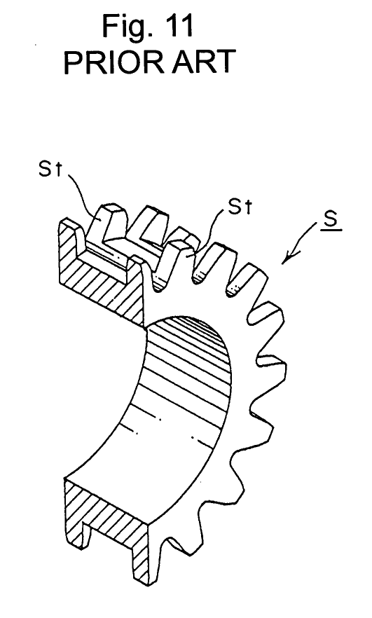

In the second embodiment of the invention, as shown in FIG. 5, the outer link plates 220a, adjacent the outermost link plates 220b, as well as the outermost link plates 220b have back surfaces that are equal in height (that is, the minimum distance measured from the tooth gap bottoms to the link plate backs are equal), but greater than the corresponding heights of the inner link plates. Thus, the outer link plates 220a and the outermost link plates 220b have flat back surfaces 223 at heights H2, which are greater than the heights H1 of the back surfaces of the inner link plates 210a and 210b. Otherwise, the configuration of the second embodiment is the same as that of the first embodiment.

As in the case of the first embodiment the link plates are preferably of the type in which the inner flanks initially engage the sprocket teeth, but the link plates become seated on the sprocket teeth with their outer flanks in contact with the sprocket teeth, as shown in FIG. 3.

The double-sided engagement type silent chain 200 in accordance with the second embodiment exhibits the same advantages as chain 100 of the first embodiment. In addition, since the heights of the back surfaces of all of the outer link plates 220a and 220b are the same, when the chain is brought into contact with the shoe of a guide or tensioner lever, the back surfaces of all the outer link plates come into sliding contact with the shoe, the contact area is increased, and shoe wear is reduced.

In summary, the performance and useful life of a double-sided engagement type silent chain can be significantly improved by making the backs of the outermost link plates higher than those of the inner link plates, and providing metallic carbide coatings on the inner circumferential surfaces of the outer link plates located adjacent the outermost link plates. Still further improvements can be realized by forming the inner circumferential surfaces of the outer link plates located adjacent the outermost link plates in a “tsuzumi” shape.

I claim:

1. A double-sided engagement type silent chain comprising a number of link plates, each having a pair of pin holes and a flat back surface, and at least some of said link plates being formed with a pair of teeth for engaging teeth of a sprocket, the link plates being interleaved in alternate rows the rows being articulably interconnected to form an endless loop by connecting pins received in the pin holes;
wherein the link plates of the chain include a plurality of inner link plates, disposed at intermediate locations in the widthwise direction of the chain, between sides thereof, said inner link plates having teeth protruding toward the interior of the loop, and a plurality of outer link plates disposed along both sides of the chain, the outer link plates including outermost link plates on both sides of the chain, and outer link plates adjacent the outermost link plates but disposed inward with respect to the outermost link plates in the widthwise direction of the chain, said pins being secured to the pin holes of the outermost link plates by an interference fit, and extending through, and fitting rotatably in, the pin holes of the other link plates;
wherein the pin holes of the outer link plates adjacent the outermost link plates have inner circumferential surfaces covered with a hardened layer consisting of at least one of metallic carbides of chromium, titanium, vanadium and niobium; and
wherein the minimum height, measured from the back surface to the tooth gap bottom of the outermost link plates is greater than the corresponding minimum height of the inner link plates.

2. A double-sided engagement type silent chain according to claim 1, in which the pin holes of the outer link plates adjacent the outermost link plates have a tsuzumi-shaped inner circumferential surface, the diameter of which is smallest at an intermediate location between the plate sides, and becomes progressively larger toward the plate sides.
